(19) United States
(12) Patent Application Publication
(10) Pub. No.: US 2015/0147529 A1
(43) Pub. Date: May 28, 2015

(54) Aircraft fuselage portion in composite material including ply drop-off with gentle slope

(71) Applicant: Airbus Operations (SAS), Toulouse (FR)

(72) Inventors: Philippe Bernadet, Colomiers (FR); Romain Delahaye, Colomiers (FR)

(21) Appl. No.: 14/548,658

(22) Filed: Nov. 20, 2014

(30) Foreign Application Priority Data
Nov. 22, 2013 (FR) 1361524

(51) Int. Cl. B64C 1/00

(52) U.S. Cl. CPC B64C 1/00; B64C 2001/0072
USPC 428/156

(57) ABSTRACT

In a fuselage portion for an aircraft, in order to reduce the assembly clearance between the soleplate of a circumferential frame and a fuselage skin in composite material while limiting the mass of the fuselage portion, a ply drop-off is used comprising two portions oriented in the circumferential direction and having different respective slopes.

### CROSS-REFERENCES TO RELATED APPLICATIONS

This application claims the benefit of the French patent application No. 13 61524 filed on Nov. 22, 2013, the entire disclosures of which are incorporated herein by way of reference.

### BACKGROUND OF THE INVENTION

The present invention relates to the field of aircraft fuselages made of composite material.

It relates to a fuselage portion for an aircraft, such as a forward section in particular, in which the circumferential frames each have a soleplate applied continuously onto the fuselage skin. Such circumferential frames are commonly called “integral frames.”

The invention is particularly advantageously applicable in the case of a forward section without stringers.

One difficulty encountered in the production of aircraft fuselages lies in the operation of assembling the circumferential frames with the fuselage skin in the case where the circumferential frames each have a soleplate in contact with the fuselage skin.

This is because this operation requires the filling of the various interstices between the soleplate of each circumferential frame and the fuselage skin, resulting from the manufacturing tolerances of these elements.

These interstices are all the greater when the fuselage skin has many regions of different thicknesses, corresponding to greater or lesser force levels to be supported.

The interstices are generally filled using solid blocks or a hardenable resin.

The operation is tedious and costly in time, in particular in the second case because of a polymerization time which generally extends to several hours.

FIG. 1 partially illustrates a forward section of an aircraft fuselage 10 of a known type, comprising a fuselage skin 12 in composite material and circumferential frames 13, the fuselage skin 12 comprising regions of different thicknesses, such as a first region 14 of greater thickness and a second region 16 of smaller thickness. These two regions are connected to one another by a ply drop-off 18.

FIG. 2 illustrates the fuselage skin 12 in cross section, and shows in particular the two regions 14 and 16 and the ply drop-off 18, as well as a portion of a soleplate 20 of complementary shape forming a portion of a circumferential frame 13 and intended to be applied to the fuselage skin 12.

FIG. 2 illustrates the manufacturing tolerances μ1 and μ2 respectively relating to the thickness D1 of the fuselage skin 12 and to the thickness D2 of the soleplate 20. These manufacturing tolerances are typically equal to approximately 0.2 mm.

FIG. 3 illustrates the fuselage skin 12 and the soleplate 20 after assembly, in the worst case, where there remains a clearance J1 corresponding to the sum of the tolerances μ1 and μ2, i.e., in the example considered, 0.4 mm.

However, to the manufacturing tolerances there is added a tolerance ε linked to the positioning of the soleplate 20 of the circumferential frame relative to the fuselage skin 12 and to the uncertainties concerning the position of the foot of the ply drop-off inherent in the methods for manufacturing skins in composite materials, as shown in FIG. 4.

This positioning tolerance ε induces a clearance J2 at the ply drop-off 18, all the more marked as the slope of this ply drop-off increases.

In the example illustrated, in which the slope of the ply drop-off 18 is equal to 1/20 and the positioning tolerance ε is equal to 12 mm, the clearance J2 thus reaches 0.6 mm.

However, a reduction of the slope of the ply drop-off 18 proves to be undesirable, in the context of the conventional fuselage portions, because of the significant increase in mass evolving from such a slope reduction.

### SUMMARY OF THE INVENTION

An aim of the invention is notably to provide a simple, economical and effective solution to this problem that makes it possible to make the operations of assembling the circumferential frames and the fuselage skins easier and more rapid, notably with respect to the forward sections.

To this end, the invention proposes a fuselage portion in composite material for an aircraft, comprising a fuselage skin comprising at least two regions of different constant thicknesses, namely a first region of greater thickness, and a second region of lesser thickness, said regions being separated from one another by a ply drop-off.

According to the invention, said ply drop-off comprises at least two portions having different slopes each oriented in a circumferential direction orthogonal to a longitudinal direction of said fuselage portion, namely a first portion having a greater slope and a second portion having a lesser slope, the first and second portions being arranged on one and the same circumferential side relative to the first region.

The slopes of the first and second portions are thus oriented in the same direction.

The invention thus proposes using a ply drop-off in two or more portions, in which the second portion has a relatively small slope allowing to reduce the assembly clearance with the soleplate of a circumferential frame, whereas the first portion has a relatively steep slope making it possible to limit the mass of said fuselage portion.

The invention preferably exhibits one or more of the optional features described below.

Said slope of said first portion of said first ply drop-off is advantageously greater than or equal to 1/20 whereas said slope of said second portion of said first ply drop-off is advantageously less than or equal to 1/40 and preferably less than or equal to 1/70.

The fuselage portion advantageously further comprises a first circumferential frame extending in a plane orthogonal to said longitudinal direction and comprising a soleplate applied to said regions of constant thickness and to said second portion of said first ply drop-off.

Said second portion of said first ply drop-off advantageously has a width between 1 times and 1.5 times the width of said soleplate of said first circumferential frame.

The fuselage portion advantageously further comprises a second circumferential frame extending in a plane orthogonal to said longitudinal direction and comprising a soleplate applied to said regions of constant thickness and to a fourth portion of said first ply drop-off similar to said second portion of said first ply drop-off and separated from said second portion by a third portion of said first ply drop-off similar to said first portion thereof.

Said fuselage skin advantageously comprises a third region of constant thickness having a thickness less than the thickness of said second region, said third region being connected to said second region by a second ply drop-off comprising at least two portions having different slopes each oriented in said circumferential direction, namely a first portion having a greater slope and a second portion having a lesser slope, the latter slope being less than said slope of said second region of said first ply drop-off, and the first and second portions of the second ply drop-off being arranged on one and the same circumferential side relative to the second region.

The fuselage portion is advantageously intended to form a forward section of an aircraft.

The invention relates also to a forward section of an aircraft, comprising a fuselage portion of the type described above.

The invention relates finally to an aircraft, comprising a fuselage portion of the type described above.

### BRIEF DESCRIPTION OF THE DRAWINGS

The invention will be better understood, and other details, advantages and features thereof will become apparent on reading the following description given as a nonlimiting example and with reference to the attached drawings in which:

FIG. 1, already described, is a partial schematic view in perspective of a fuselage portion of a known type, intended to form a portion of the forward section of an aircraft;

FIGS. 2 to 4, already described, are partial schematic views in cross section of the fuselage portion of FIG. 1;

FIG. 5 is a partial schematic view in perspective of a fuselage portion according to a preferred embodiment of the invention, intended to form the forward section of an aircraft;

FIG. 6 is a partial schematic view of the fuselage skin of the fuselage portion of FIG. 5, seen in the radial direction, from the interior of said fuselage portion;

FIG. 7 is a partial schematic view in cross section of the fuselage portion of FIG. 5;

FIGS. 8 to 11 are views similar to FIG. 6, but on a larger scale, illustrating different ply configurations of a fuselage skin ply drop-off of FIG. 6.

In all these figures, identical references can denote identical or analogous elements.

### DETAILED DESCRIPTION OF THE PREFERRED EMBODIMENTS

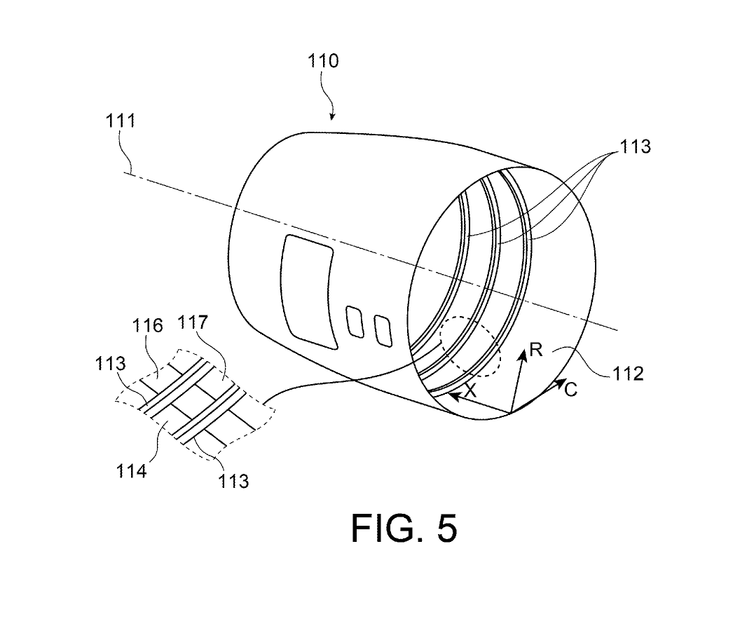

FIG. 5 illustrates a fuselage portion 110 intended to form a forward section of an aircraft fuselage. This fuselage portion 110 extends along an axis 111 defining a longitudinal direction X of the fuselage portion. Radial R and circumferential C directions are also defined by reference to the axis 111.

This fuselage portion 110 comprises a fuselage skin 112 in composite material and circumferential frames 113 intended to rigidify the fuselage skin 112, in a manner known per se.

In the example illustrated, the fuselage portion 110 has no stringers, that is to say longitudinal stiffeners. The rigidity of the fuselage skin 112 is thus obtained through the thickness of this skin, in a manner known to those skilled in the art.

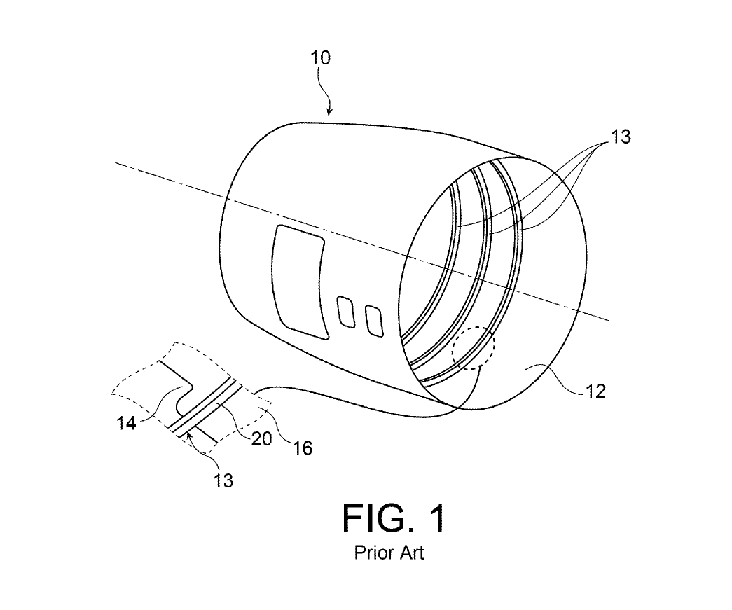

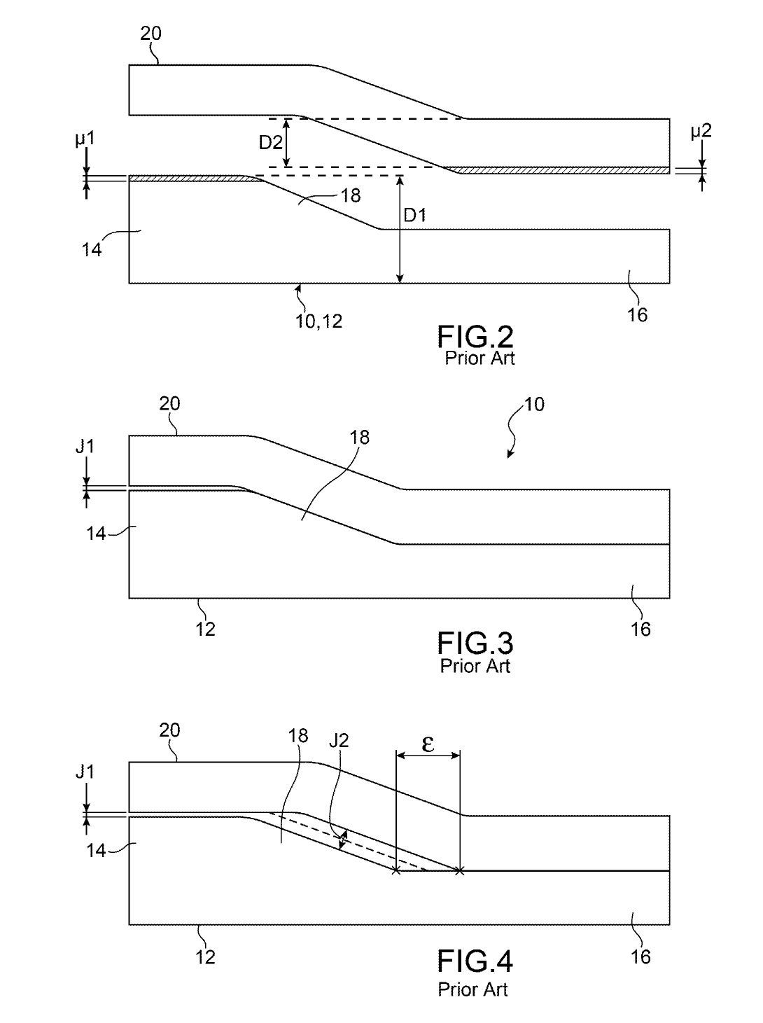

As in the example of FIG. 1 described above, the fuselage skin 112 comprises regions of different thicknesses, suited to local variations of the force level that the fuselage skin 112 has to withstand.

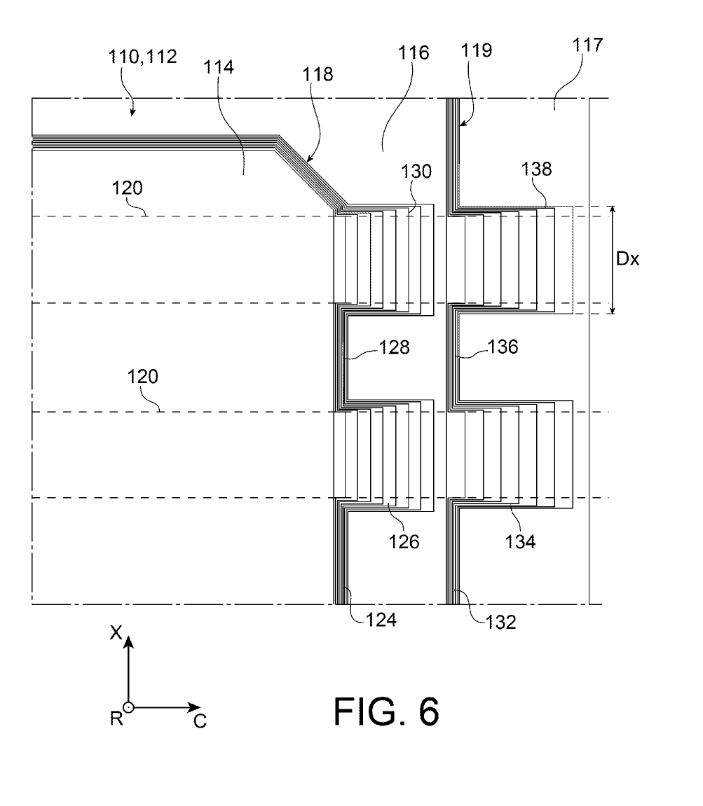

FIG. 6 represents a portion of the fuselage skin 112 seen along the radial direction R, from the interior of the fuselage portion 110. This figure reveals three regions of different thicknesses, namely a first region 114 of greater thickness, a second region 116 of lesser thickness, and a third region 117 of even smaller thickness.

The first region 114 is connected to the second region 116 by a first ply drop-off 118, whereas the second region 116 is connected to the third region 117 by a second ply drop-off 119.

FIG. 6 also reveals, in broken lines, the respective positions of two soleplates 120 belonging respectively to two consecutive circumferential frames 113.

According to a particular feature of the present invention, the first ply drop-off 118 comprises a plurality of portions having different slopes oriented in the circumferential direction C, in the same direction about the axis 111, for example in the counter-clockwise direction when the fuselage portion 110 is seen from the rear, that is to say when it is seen from right to left in FIG. 5.

Thus, FIG. 6 reveals a first portion 124 having a slope equal to 1/20 for example and a second portion 126 having a slope equal to 1/70 for example. The respective slopes of the portions 124 and 126 of the first ply drop-off 118 are oriented in the same direction, in this case from left to right in FIG. 6. These two portions 124 and 126 of the first ply drop-off 118 are substantially adjacent in the longitudinal direction X. In other words, these two portions 124 and 126 are separated from one another by a limit extending in the circumferential direction C.

FIG. 6 further reveals two other portions of the ply drop-off 118, namely a third portion 128 having a slope equal to 1/20 for example, and a fourth portion 130 having a slope equal to 1/70 for example.

As FIG. 6 shows, the second ply drop-off 119 is similar to the first ply drop-off 118, and therefore has a first portion 132, a second portion 134, a third portion 136 and a fourth portion 138.

However, in the example illustrated, the slope of the second and fourth portions 134, 138 is equal to approximately 1/100, and is therefore less than the slope of the second and fourth portions 126, 130 of the first ply drop-off 118.

As can be seen in FIG. 6, the respective soleplates 120 of the abovementioned two circumferential frames 113 are applied respectively to the second 126, 134 and fourth 130, 138 portions of each of the two ply drop-offs 118 and 119. The width Dx of each of these portions of the ply drop-offs is advantageously between 1 times and 1.5 times the width of the soleplate 120 of each circumferential frame. The width of each ply drop-off portion should be understood to be the extent, in the longitudinal direction X, of the widest ply of the portion considered of the ply drop-off.

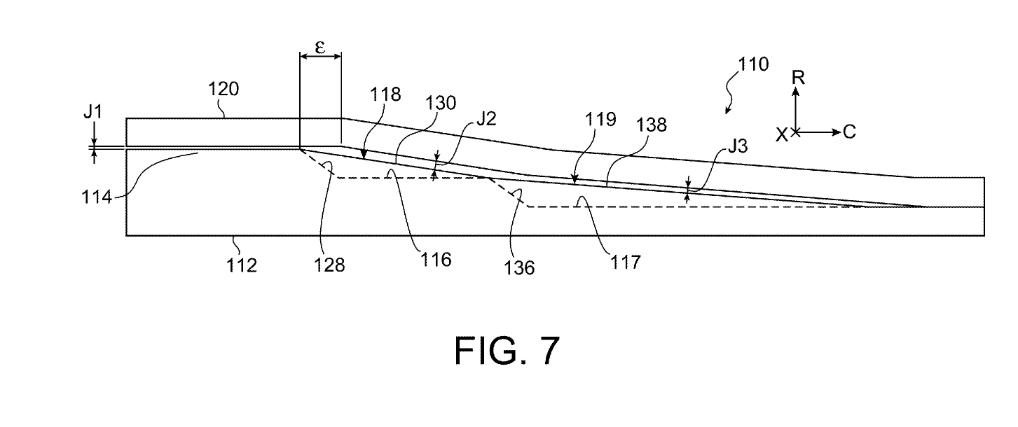

As illustrated in FIG. 7, the relatively shallow slope of the fuselage skin 112 and of the soleplate 120 of each circumferential frame, at the point of contact between these elements, makes it possible to considerably reduce the clearance resulting from the positioning tolerance ε of the circumferential frames.

Thus, in the worst case, that can be seen in FIG. 7, with a positioning tolerance ε equal to 12 mm, the clearance J2 at the first ply drop-off 118 is approximately equal to 0.2 mm, and the clearance J3 at the second ply drop-off 119 is even reduced to approximately 0.1 mm.

On the other hand, the first 124, 132 and the third 128, 136 portions of each of the ply drop-offs 118, 119 correspond to areas of the fuselage skin 112 situated between the circumferential frames, in which the greater slope makes it possible to limit the overall mass of the fuselage portion 110.

The second portions 126, 134 and the fourth portions 130, 138 of the ply drop-offs 118, 119 can be produced concomitantly with the fuselage skin 112. In each of these portions with relatively shallow slope, the orientation of the fibers of each ply is determined as a function of the circumferential extent and of the longitudinal extent of the ply within the ply drop-off considered, and as a function of a minimum lay-up length imposed by the toolage used. Preferably, the ply drop-offs comprise an alternation of plies comprising fibers oriented at 90 degrees and of plies comprising fibers oriented at zero degrees.

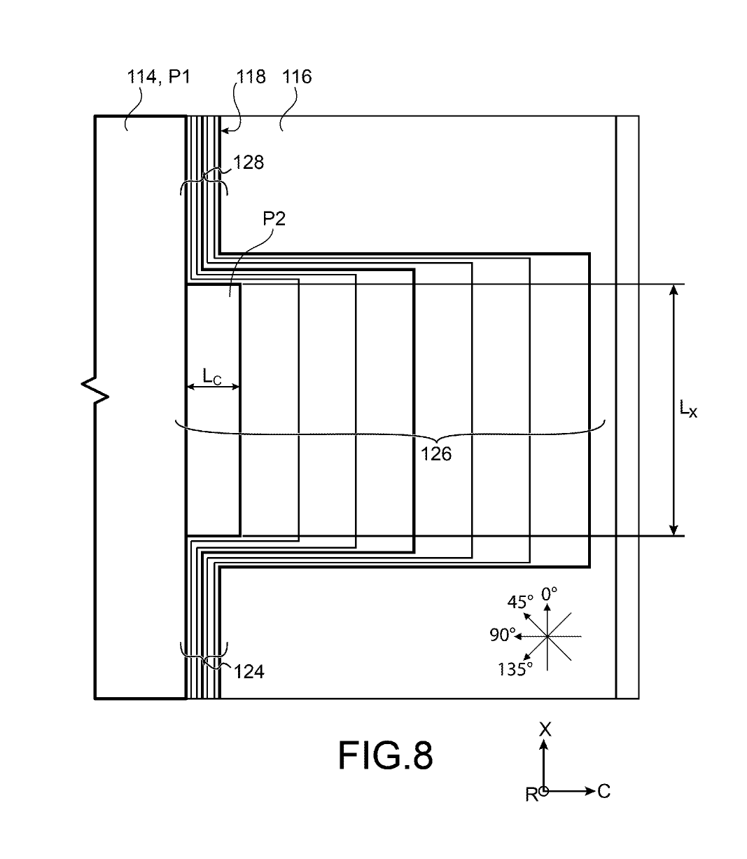

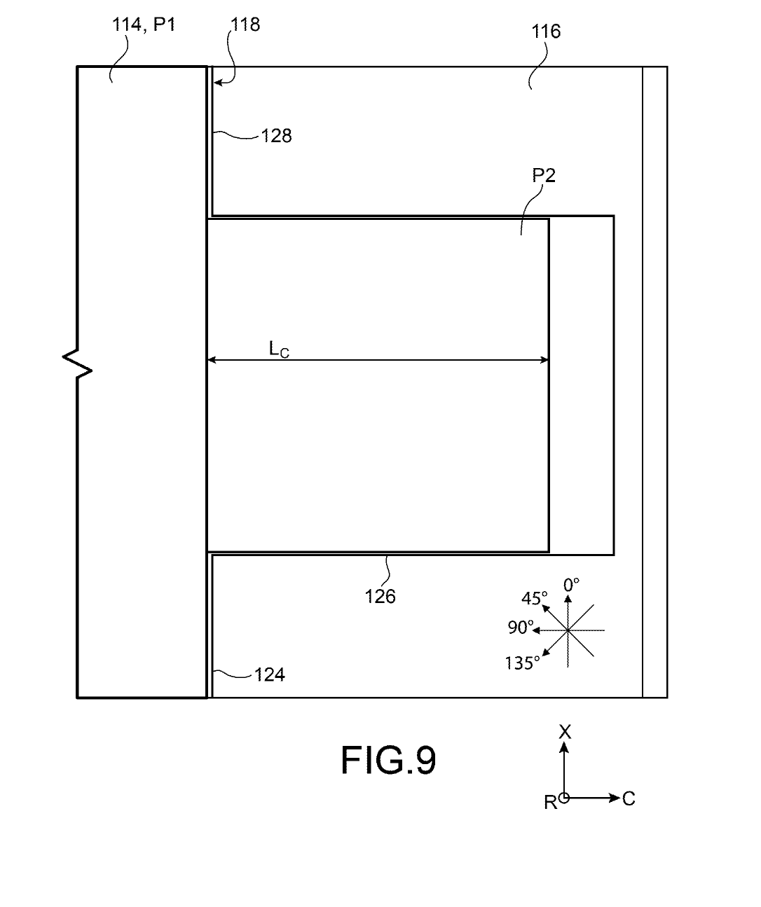

In particular, for a ply P1 of the region 114 to be extended having fibers oriented at 45 degrees or at 135 degrees (FIG. 8), when the additional ply P2 of the ply drop-off 118 has a circumferential extent Lc less than the minimum lay-up length and a longitudinal extent Lx greater than the minimum lay-up length, the fibers of this additional ply P2 are preferably oriented at zero degrees. On the other hand, when the additional ply P2 of the ply drop-off 118 has a circumferential extent Lc greater than the minimum lay-up length (FIG. 9), the fibers of this additional ply P2 are preferably oriented at 90 degrees.

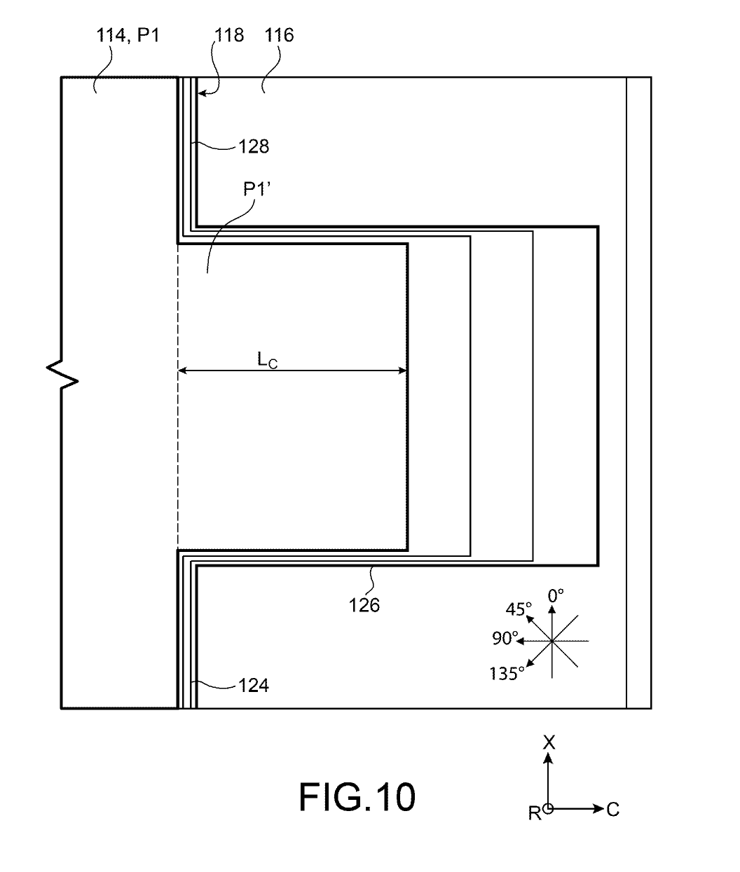

For a ply P1 of the region 114 to be extended that has fibers oriented at 90 degrees (FIG. 10), when the additional ply P1′ of the ply drop-off 118 has a circumferential extent Lc greater than the minimum lay-up length, the fibers of this additional ply P1′ are preferably oriented at 90 degrees. The additional ply P1′ can then be formed integrally with the ply P1 of the region 114.

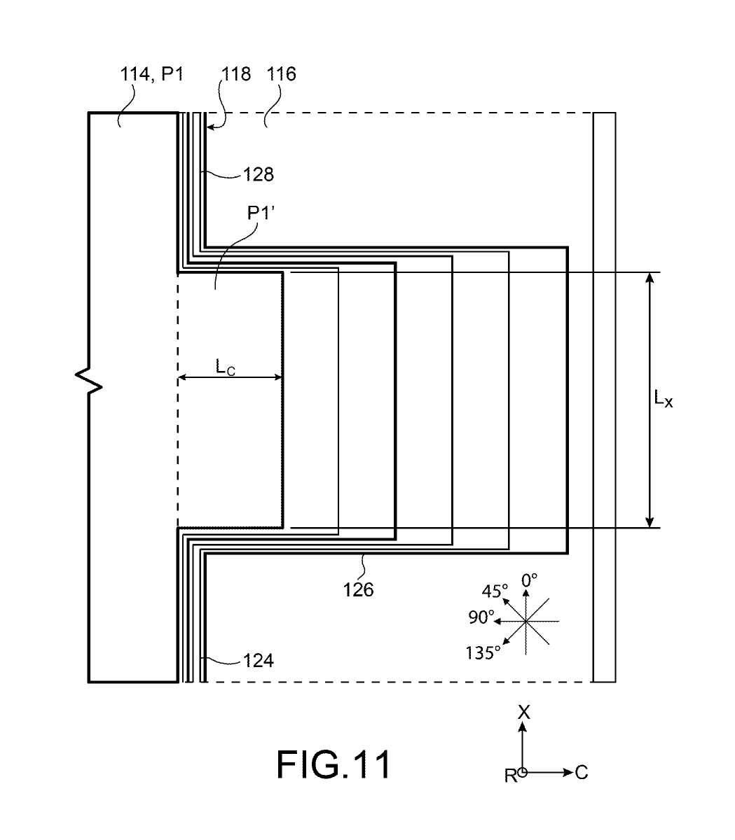

Similarly, for a ply P1 of the region 114 to be extended that has fibers oriented at zero degrees (FIG. 11), when the additional ply P1′ of the ply drop-off 118 has a longitudinal extent Lx greater than the minimum lay-up length, the fibers of this additional ply P1′ are preferably oriented at zero degrees. The additional ply P1′ can then be formed integrally with the ply P1 of the region 114.

Generally, the invention therefore makes it possible to reduce the clearances induced by the manufacturing tolerances, at the point of contact between the soleplate of each circumferential frame and the fuselage skin in a fuselage portion for an aircraft, while limiting the mass of the fuselage portion.

It should be noted that, in the example illustrated, the absence of stringers makes it possible to obtain a fuselage skin 112 totally without steps at the level of each of the circumferential frames 113.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A fuselage portion formed of composite material for an aircraft, comprising:
a fuselage skin comprising at least two regions of constant thickness having different thicknesses, comprising
a first region of greater constant thickness, and
a second region of lesser constant thickness, said regions being connected to one another by a first ply drop-off,
said first ply drop-off comprising at least two portions having different slopes each oriented in a circumferential direction orthogonal to a longitudinal direction of said fuselage portion, comprising
a first portion having a greater slope and
a second portion having a lesser slope,
the first and second portions being arranged on one and the same circumferential side relative to the first region.

2. The fuselage portion according to claim 1, wherein said slope of said first portion of said first ply drop-off is greater than or equal to 1/20 and said slope of said second portion of said first ply drop-off is less than or equal to 1/40.

3. The fuselage portion according to claim 2, wherein said slope of said second portion of said first ply drop-off is less than or equal to 1/70.

4. The fuselage portion according to claim 1, further comprising a first circumferential frame extending in a plane orthogonal to said longitudinal direction and comprising a soleplate applied to said regions of constant thickness and to said second portion of said first ply drop-off.

5. The fuselage portion according to claim 4, wherein said second portion of said first ply drop-off has a width between 1 times and 1.5 times a width of said soleplate of said first circumferential frame.

6. The fuselage portion according to claim 4, further comprising a second circumferential frame extending in a plane orthogonal to said longitudinal direction and comprising a soleplate applied to said regions of constant thickness and to a fourth portion of said first ply drop-off similar to said second portion of said first ply drop-off and separated from said second portion by a third portion of said first ply drop-off similar to said first portion thereof.

7. The fuselage portion according to claim 1, wherein said fuselage skin comprises
a third region of constant thickness having a thickness less than the thickness of said second region,
said third region being connected to said second region by a second ply drop-off comprising at least two portions having different slopes each oriented in said circumferential direction, comprising
a first portion having a greater slope and
a second portion having a lesser slope, the latter slope being less than said slope of said second region of said first ply drop-off, and
the first and second portions of the second ply drop-off being arranged on one and the same circumferential side relative to the second region.

8. The fuselage portion according to claim 1, wherein the fuselage portion comprises a forward section of an aircraft.

9. A forward section of an aircraft comprising a fuselage portion formed of composite material, comprising:
a fuselage skin comprising at least two regions of constant thickness having different thicknesses, comprising
a first region of greater constant thickness, and
a second region of lesser constant thickness, said regions being connected to one another by a first ply drop-off,
said first ply drop-off comprising at least two portions having different slopes each oriented in a circumferential direction orthogonal to a longitudinal direction of said fuselage portion, comprising
a first portion having a greater slope and
a second portion having a lesser slope,
the first and second portions being arranged on one and the same circumferential side relative to the first region.

10. An aircraft comprising a forward section comprising a fuselage portion formed of composite material, comprising:
a fuselage skin comprising at least two regions of constant thickness having different thicknesses, comprising
a first region of greater constant thickness, and
a second region of lesser constant thickness, said regions being connected to one another by a first ply drop-off,
said first ply drop-off comprising at least two portions having different slopes each oriented in a circumferential direction orthogonal to a longitudinal direction of said fuselage portion, comprising
a first portion having a greater slope and
a second portion having a lesser slope,
the first and second portions being arranged on one and the same circumferential side relative to the first region.
